(19) United States
(12) Patent Application Publication
(10) Pub. No.: US 2010/0308809 A1
(43) Pub. Date: Dec. 9, 2010

(54) PIPELINE GEOMETRY SENSOR

(76) Inventors: Peter Houldley, Rowlands Gill (GB); Paul Arthur Mundell, Rowlands Gill (GB)

Correspondence Address: General Electric Company;GE Global Patent Operation, 2 Corporate Drive, Suite 648, Shelton, CT, 06484, US

(21) Appl. No.: 12/682,171

(22) PCT Filed: Oct. 13, 2008
(86) PCT No.: PCT/GB08/03469

§ 371 Date: Apr. 8, 2010

(30) Foreign Application Priority Data
Oct. 18, 2007 (GB) 0720446.4

(51) Int. Cl. G01N 27/82

(52) U.S. Cl. 324/220

(57) ABSTRACT

A sensor module (100) for a pipeline vehicle (110) is disclosed. The sensor module (100) includes an outwardly biased sensor arm (120) pivotally connected at a hinge (129) mounted on the vehicle (110), whereby the angle between the sensor arm (120) and pipeline vehicle (110) is representative of a pipeline dimension. A magnet (240) and magnetic flux sensor (252) are mounted in the sensor module (100) to move relative to one another as the sensor arm (120) pivots relative to the vehicle (110). Measurement of change in magnetic flux can permit determination of the angle between the sensor arm and the vehicle. The sensor module (100) may be mounted on an upstanding flange (111) via a compliant (deformable) layer (202) which permits lateral deflection of the module (100) relative to the vehicle (110).

### BACKGROUND OF THE INVENTION

1. Field of the Invention

The present invention relates to pipeline vehicles, e.g. vehicles adapted to travel within a pipeline for cleaning or inspection purposes. For example, the invention may relate to inspection sensor modules for pipeline inspection vehicles (known as pipeline pigs) which can determine the internal geometry of a pipeline.

2. Summary of the Prior Art

It is known to inspect the inside of a pipeline using a pipeline pig which may comprise one or more interconnected vehicles which pass down the pipe.

Pipeline inspection vehicles typically comprise a main central body to which sensors or other components are mounted. The vehicles may be equipped with cleaning tools for removing debris and contamination from the wall of the pipeline, and sensors for determining the pipeline integrity.

The pig may be towed along the pipeline, or be fitted with pressure plates which enable propulsion by a difference in pressure across the pressure plate. Knowledge of pipeline defects is critical in preventing future pipeline failure. Defects of particular importance include cracks, regions of metal loss (due to corrosion, for example), and distortions such as dents. Metal loss and cracking are typically identified using sensors such as magnetic flux sensors and/or ultrasound sensors. These sensors are usually mounted on the outer end of sensor arms that are themselves hingedly connected to the pipeline inspection vehicle. There will be a plurality of such sensor arms, usually arranged circumferentially around the pig. Individual sensor arms can be resiliently biased against the pipeline wall using a variety of spring mechanisms so as to provide compliance over portions of the inner wall of varying diameter.

By monitoring the orientation of the sensor arms relative to the pipeline inspection vehicle, the internal geometry of the pipeline may also be determined. The orientation of the sensor arms may be measured by rotary potentiometers or shaft encoders, which are fitted to the axle at the base of the sensor arm, about which the sensor arm is pivoted.

However, rotary potentiometers and shaft encoders are bulky components and can prevent sensor arms being placed close together. Thus, when using these components, there is a limit to the number of sensor arms that can be provided on an outer surface of the pipeline inspection vehicle. Hence the resolution with which the interior geometry of the pipeline can be determined is also limited. Furthermore, rotary potentiometers and shaft encoders may be unsuitable for use in high pressure and dirty environments where they could be susceptible to damage due to the effects of pressure, or ingress of product or debris.

WO 2006/003392 describes an inspection sensor module for a pipeline inspection vehicle in which a sensor arm is biased outwardly from the inspection vehicle by a leaf spring and movement of the sensor arm relative to the body of the inspection vehicle is measured by strain gauges attached to the leaf spring.

### SUMMARY OF THE INVENTION

At its most general, the present invention proposes monitoring the movement of a sensor arm by detecting relative movement between a magnetic flux sensor and a magnetic field. Relative movement between the magnetic flux sensor (e.g. a Hall effect sensor) and a magnet can cause the detector to detect a change in magnetic field. The detected change can permit the extent of corresponding movement of the sensor arm to be determined.

In one arrangement, the magnetic flux sensor may be mounted on a sensor arm that is mounted on and movable relative to a pipeline vehicle e.g. to detect changes in pipe structure. The fixed magnetic field may be achieved by fixedly attaching one or more magnets to the pipeline vehicle.

The inventors have discovered that by fixing the magnet to the pipeline vehicle (i.e. so that the position of the magnet is unaffected by the position of the sensor arm), any interaction between magnets of adjacent sensor modules remains fixed (i.e. does not change) and can readily be accounted for when evaluating the data recorded by a magnetic flux sensor positioned on the sensor arm. Thus, by moving the sensor relative to the vehicle rather than moving a magnetic field relative to the vehicle an even more accurate measurement system can be achieved.

Thus, the present invention may provide a sensor module for a pipeline vehicle, the module having a support structure for mounting the module on the vehicle; a sensor arm that is movable relative to the support structure; a magnet mounted on one of the support structure and sensor arm; and a magnetic flux sensor mounted on the other one of the support structure and sensor arm, wherein the magnet and magnetic flux sensor are movable relative to one another to detect the position of the sensor arm relative to the support structure. Such a sensor module may be more robust than those which use e.g. strain gauges to detect relative movement e.g. because there are fewer moving or otherwise delicate parts in the detection structure.

The magnet may be mounted on the support structure, e.g. so that it is fixed relative to the vehicle, and the magnetic flux sensor may be mounted on the sensor arm to move therewith relative to the support structure (and fixed magnet).

Preferably, the sensor arm is connected at one end to the support structure. The sensor arm may be pivotally connected to the support structure. The sensor arm may be hingedly connected to the support structure. In one embodiment with a hinged connection between the sensor arm and the support structure, the support structure may house the axle for the sensor arm.

Thus, the magnetic flux sensor mounted on the sensor arm may detect the orientation, i.e. angular position, of the sensor arm relative to the support structure.

The sensor module may include biasing means for biasing the sensor arm towards a deployed position relative to the support structure. The sensor arm may be resiliently biased towards the deployed position, for example, by leaf springs, torsion springs, a resilient bushing or the like. Thus, when the sensor module is mounted on the pipeline vehicle, the end of the sensor arm remote from the pipeline vehicle may abut the inner wall of a pipe. If a deformation in the pipe wall is encountered, the end of the sensor arm remote from the pipeline vehicle will move radially to conform to the inner wall of the pipe. This movement will cause relative movement between the magnetic flux sensor (e.g. mounted on the sensor arm) and the magnet mounted (e.g. mounted on the support structure), whereby the magnetic flux sensor registers a change in magnetic field. The change in magnetic field may permit the position of the sensor arm, and hence the geometry of the pipeline, to be determined. By positioning the magnet on the support structure for the sensor arm, the position of the magnet remains fixed relative to the body of the pipeline vehicle when the sensor module is mounted on the vehicle. Thus, the position of the magnet may be fixed relative to other magnets provided by other sensor modules, and the level of interaction between magnets on different sensor modules is unchanging (and can be calculated or measured). The effect of this interaction on the reading obtained from the magnetic flux sensor mounted on the sensor arm can therefore be compensated or corrected.

The magnetic flux sensor may be arranged on the sensor arm so that it is embedded within the arm. Similarly, the magnet may be mounted on the support structure so that it is at least partly embedded in this structure. Hence, a compact sensor module may be provided. Such compact sensors modules may be mounted on the surface of the pipeline vehicle in a closely-spaced arrangement, thus providing a high density of sensor arms on the pipeline vehicle. This arrangement allows the internal geometry of the pipeline to be determined with a high degree of resolution.

It is preferable that the motion of the sensor arm relative to the support structure is such that the magnetic flux sensor traverses a region of significant change in magnetic flux density around the magnet. The magnet may be configured to present such a region at the interface between the magnet and the magnetic flux sensor. Thus, the position of the sensor arm relative to the support structure may be measured with a high degree of precision. The support structure is preferably of ferrous material to act as a magnetic yoke to facilitate configuration of the magnetic field in use. The sensor arm may also comprise an inspection sensor (e.g. a sensor block) for detecting e.g. metal loss or cracking in the pipeline wall. This inspection sensor may be located at the end of the sensor arm remote from the support structure. The inspection sensor may itself be a magnetic flux sensor or it may be an ultrasonic transducer, an electro-magnetic acoustic transducer, or a pulsed eddy-current sensor.

By providing a sensor module that is adapted to determine pipeline geometry as well as detecting defects such as thinning or cracking of the pipeline wall, the spatial relationship between these defects and features of the pipeline geometry may be established.

The magnetic flux sensor is preferably encased within a protective covering. This allows the sensor module to be used in high pressure environments. The magnetic flux sensor may be a Hall-effect sensor.

The magnet may be a rare earth magnet, such as samarium-cobalt or neodymium-iron-boron.

The above discussion has illustrated the present invention in terms of a sensor module. A second aspect of the invention may provide a pipeline vehicle having at least one, preferably a plurality, of such sensor modules mounted on its surface.

The pipeline vehicle according to the second aspect of the invention may have a plurality of sensor modules provided circumferentially around a body of the vehicle, so that the movement of each sensor arm towards or away from the body of the vehicle is a radial movement in the pipe.

In one embodiment, the support structure of the sensor module may be mounted on an upstanding (e.g. radially extending) flange on the outer surface of the body of the pipeline vehicle. The flange may be integral with the body or part of a separate collar mounted thereon. The support structure may include a layer of deformable, e.g. compliant, material between the support structure and flange to permit sideways deflection of the sensor module relative to the vehicle in an axial direction. This can enable the sensor module to react more robustly to sideways forces that can be exerted when the vehicle travels through curves in the pipe. The layer of deformable (preferably resilient) material may give the module enough Λplay′ with respect to the body to enable a pivotal connection between a sensor arm and support structure to be rigid e.g. to reduce or eliminate variations in a travel path of the sensor arm relative to the support structure. The deformable layer may be an independent aspect of the invention. According to that aspect there may be provided a pipeline vehicle having a sensor module mounted thereon, the sensor module including a sensor arm pivotally connected to a support structure, the support structure being mounted on vehicle to permit relative movement between the sensor arm and vehicle, wherein a deformable layer is mounted between the support structure and the vehicle to permit lateral deflection of the sensor module relative to the vehicle. The sensor arm may be constrained to pivot in a flat plane relative to the support structure, and the permitted deflection may enable relative movement between that plane and the vehicle.

A further aspect of the present invention may provide a method of monitoring the characteristics of a pipe using a sensor module according to the first or second aspect.

### BRIEF DESCRIPTION OF THE DRAWINGS

An embodiment of the present invention will now be described in detail, by way of example, with reference to the accompanying drawings, in which:

FIG. 1 is an oblique view of a sensor module that is an embodiment of the present invention, mounted on a pipeline vehicle;

FIG. 2 is an oblique view of the sensor module of FIG. 1 which is cut away to show its internal structure;

FIG. 3 is a side view of the cut away sensor module shown in FIG. 2;

FIG. 4 is a schematic representation of the magnet and P-shaped support bracket of the sensor module;

FIG. 5 is an oblique view of a sensor module that is another embodiment of the present invention, mounted on a pipeline vehicle;

FIG. 6 is an illustration of a distribution of magnetic flux lines for a section through the P-shaped support block shown in FIG. 4; and

FIG. 7 is a graph showing typical variation of a tangential component of magnetic field with sensor angle for a sensor module that is an embodiment of the invention.

### DETAILED DESCRIPTION

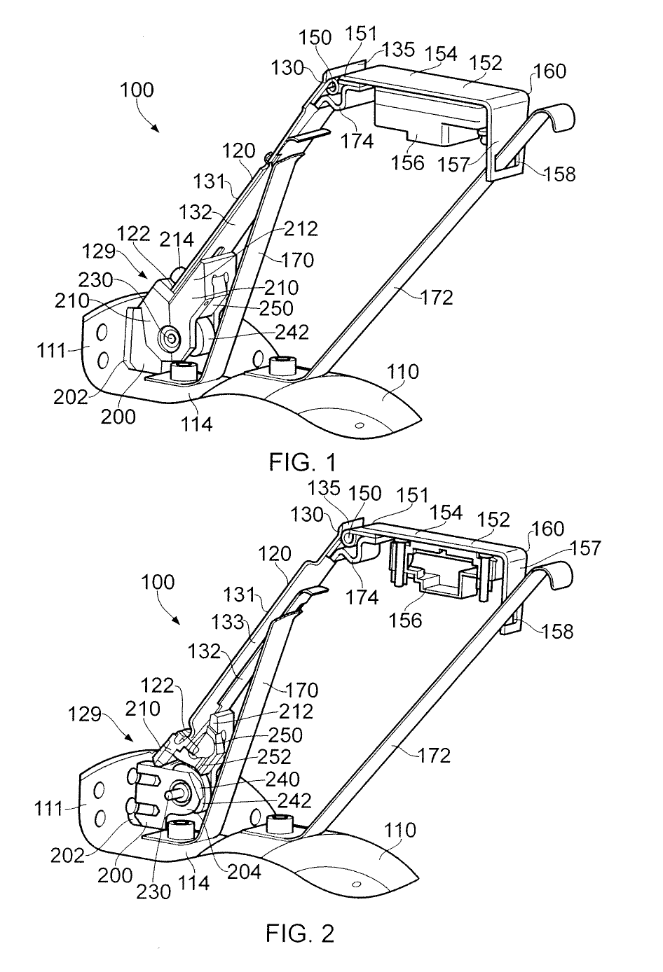

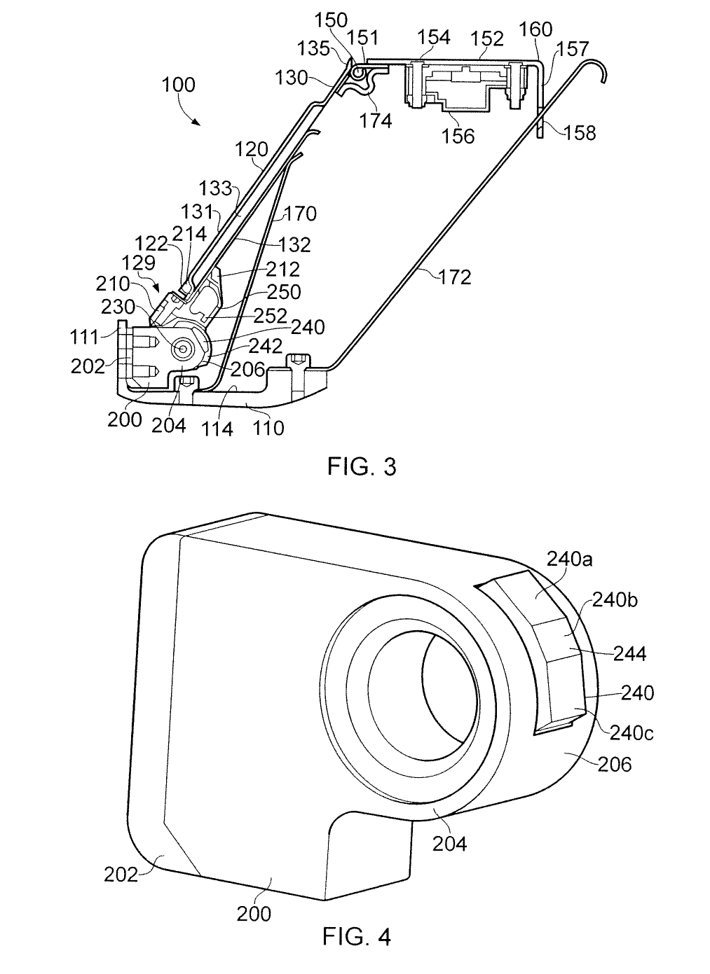

FIGS. 1, 2 and 3 illustrate a sensor module 100 according to an embodiment of the invention. The sensor module 100 is mounted on an upstanding flange 111 on an outer surface of a pipeline vehicle 110. Although not shown in FIGS. 1-3, a plurality of such inspection sensor modules 100 may be provided circumferentially around the pipeline vehicle 110, with each sensor module 100 extending laterally from the pipeline vehicle 110. When the pipeline vehicle 110 is being used for inspecting a pipeline, the inspection sensor modules 100 extend radially from the pipeline vehicle 110, and each inspection sensor module 100 abuts a portion of the inner wall of the pipeline. The sensor module 100 comprises a sensor arm 120 having a proximal end 122 that is connected to the pipeline vehicle 110 by a first hinge 129. The distal end 130 of the sensor arm 120 is connected to a sensor sledge 152 by a second hinge 150. The sensor sledge 152 has an inspection surface 154 for contacting (sliding relative to) the inner wall of a pipeline (not shown) during inspection. A sensor block 156 is mounted on the sensor sledge 152. The hinges 129 and 150 are oriented so as to permit lateral (radial) deployment of the sensor sledge 152 relative to the pipeline vehicle 110.

FIGS. 1 to 3 show the inspection sensor module 100 in the deployed condition such that the sensor arm 120 extends laterally, e.g. radially, from the pipeline vehicle 110 and the inspection surface 154 of the sensor sledge 152 is pressed against the inner wall of the pipeline (not shown). The inspection sensor module 100 is held in the deployed position by first and second leaf springs 170, 172 that abut, e.g. are mounted on, a platform 114 e.g. an outward facing surface on the pipeline vehicle 110. The second hinge 150 is resiliently biased by a third spring 174 towards a position in which the sensor sledge 152 extends along the axis of the sensor arm 120.

The first leaf spring 170 contacts a back face 132 of the sensor arm 120 so as to cause the sensor arm 120 to assume a deployed position. The front face 131 of the sensor arm 120 has a raised portion which forms a cavity 133 when the back face 132 is mounted thereon. The purpose of the cavity 133 is discussed below.

The second leaf spring 172 passes behind a sensor block 156 mounted on the underside of the sledge 152 and through a spring aperture 158 formed in a downward flange 157 at the back end of the sledge 152. The spring aperture 158 allows the leaf spring to slide freely therein so as to allow the sledge 152 to move between deployed and retracted positions without experiencing excessive torque. The action of the first leaf spring 170 causes the sensor arm 120 to be biased to a radially deployed position such that the hinge 150 lies remote to the pipeline vehicle 110 and adjacent to the inner wall of the pipeline (not shown). The action of the second leaf spring 172 and the third spring 174 is such as to press the trailing edge 160 of the sledge 152 against the inner wall of the pipeline (not shown). Thus, the action of the three springs 170, 172 and 174 is to maintain the sledge 152 aligned with the inner wall of the pipeline (not shown). According to this embodiment the tip of the second end 130 of the sensor arm 120 is flared in a direction radially outward so as to form a lip 135. The purpose of the lip 135 is to prevent snag of the leading edge 151 of said sledge 152 against imperfections (e.g. projection, cracks or the like) in the surface of the pipeline inner wall. Such snag might result in damage to the inspection sensor module 100. The structure of the first hinge 129 will now be described in more detail. The first hinge 129 comprises a P-shaped support bracket 200, a Clevis block 210, and a pin 230.

The P-shaped support bracket 200 acts as a support structure for mounting the inspection sensor module 100 on the pipeline vehicle 110. The P-shaped support bracket 200 has a mounting portion 202 that is affixed to the upstanding flange 111 of the pipeline vehicle 110 by screwed fixings. The mounting portion 202 comprises a compliant layer bonded to a mounting face of the P-shaped support bracket 200. The compliant layer may be made from polyurethane and in this particular embodiment is 2 mm thick. The compliant layer permits lateral deflection of the sensor module 100 relative to the pipeline vehicle 110. This may permit a rigid hinge 129 to be used, which aids the accuracy of the magnetic flux sensor arrangement discussed below. The thickness of the layer, the degree of Shore hardness of the material and surface area are variable, and are determined by testing and calculation, so that the required degree of deflection is achieved for a given side load at the uppermost point of the sensor sledge 152. The required degree of deflection will depend on a number of factors, including, but not limited to, bend radius of pipe, diameter of pipe, wall thickness of pipe, valve bore, local restrictions, sensor location and vehicle geometry.

The P-shaped support bracket 200 has a head 204 that is distal from the mounting portion 202.

The Clevis block 210 has a body 212 that is affixed to the sensor arm 120 by screwed fixings 214. Two legs extending from the body 212 to straddle the head 204 of the P-shaped support block 200 and are secured to it by the pin 230 passing through each leg and the head 204.

Thus the body 212 of the Clevis block 210 is able to move along an arc centred on the axis defined by the pin 230. The head 204 of the P-shaped support bracket 200 is partly bounded by a curved surface 206 that is also centred on the axis defined by the pin 230. Hence the body 212 of the Clevis block 210 is able to move along an arc that is concentric with the curved surface 206 of the head 204 of the P-shaped support bracket 200.

A magnet 240 is partly embedded in the curved surface 206 of the head 204 of the P-shaped support bracket 200 and is protected by a cover 242.

A housing 250 is encompassed by the body 212 of the Clevis block 210 and encloses a magnetic flux sensor (Hall-effect sensor) 252. The Hall-effect sensor 252 is positioned in the region of the housing proximal to the head 204 of the P-shaped support bracket.

When the pipeline vehicle 110 travels along a pipeline, the sensor arm 120 rotates in response to the varying geometry of the pipeline. This rotation causes the Hall-effect sensor 252 that is affixed to the base of the sensor arm 120 to rotate about the pin 230 and thus move relative to the magnet 240. The Hall voltage generated by the Hall-effect sensor 252 varies in response to the changing magnetic field experienced by the sensor 252. Thus, the position of the sensor arm 120 and the geometry of the inner wall of the pipeline may be determined.

Effectively, the Hall effect sensor 252 traces an arc around the magnet 240 as the sensor arm 120 rotates. The change in field shape and amplitude of the magnetic field detected by the Hall effect sensor 252 may then be translated into an angular measurement from which the geometry of the pipeline may be deduced.

The Hall effect sensor 252 of this embodiment measures the change in the tangential component of the magnetic field with angle. By positioning the magnet 240 on a component of the hinge that is fixed relative to the pipeline vehicle 110 (i.e. the P-shaped support bracket 200), the level of interaction between this magnet and the magnets of adjacent inspection sensor modules 100 on the surface of the pipeline vehicle 110 does not change even when adjacent sensor arms move in different ways. Thus only a simple correction to the signal obtained from the Hall-effect sensor 252 is required in order to account for this interaction. In this embodiment of the invention, housing for the Hall effect sensor 252 abuts the back face 132 of the sensor arm 120. The output harness (not shown) of the Hall effect sensor is connected to the sensor block 156. Where wired connections (also not shown) are used, they pass through the cavity 133 in the sensor arm 120 so as not to interfere with the springs or hinges. The Hall effect sensor 252 does not protrude from the sensor arm 120 along the axial direction of the hinge 129.

The arrangement of each Hall effect sensor 252 and the magnet 240 allows a compact sensor inspection module 100 to be provided. As a result, a large number of these modules may be mounted on a pipeline vehicle 110. Hence, the pipeline geometry may be determined with a high degree of spatial resolution. At the same time the interaction between the magnets of the different sensor inspection modules 100 remains readily quantifiable.

Because the magnet 240 and the Hall effect sensor 252 are protected by a protective cover 242 and a housing 250 respectively, the sensor inspection module 100 may be used in high pressure or corrosive environments. When covered the magnet is better protected from loose debris in the pipe. Without the cover, such debris can become trapped in hinges may affect the magnetic field produced by the magnet 240. Neither the protective cover 242 nor the housing 250 interferes with the magnetic field from the magnet 240 and hence the performance of the sensor inspection module 100 is not compromised. The magnet 240 may be a dipole magnet that is magnetized in the through thickness direction, so that one pole is located at the exposed surface of the magnet 240. Thus, the magnetic field exits the magnet in a radial direction relative to the exposed surface of the magnet 240 and the curved surface 206 of the P-shaped support bracket 200.

The P-shaped support bracket 200 is preferably of a ferrous material so that it can act as a magnetic yoke, thus providing a return path for the magnetic flux. Most preferably, the P-shaped support bracket 200 is made of mild steel.

Thus, the magnetic flux lines exit the surface of the magnet 240 in a radial direction relative to the curved surface 206 of the head 204 of the P-shaped support bracket 200, and then curve outwards so that they are directed to the P-shaped support bracket 200.

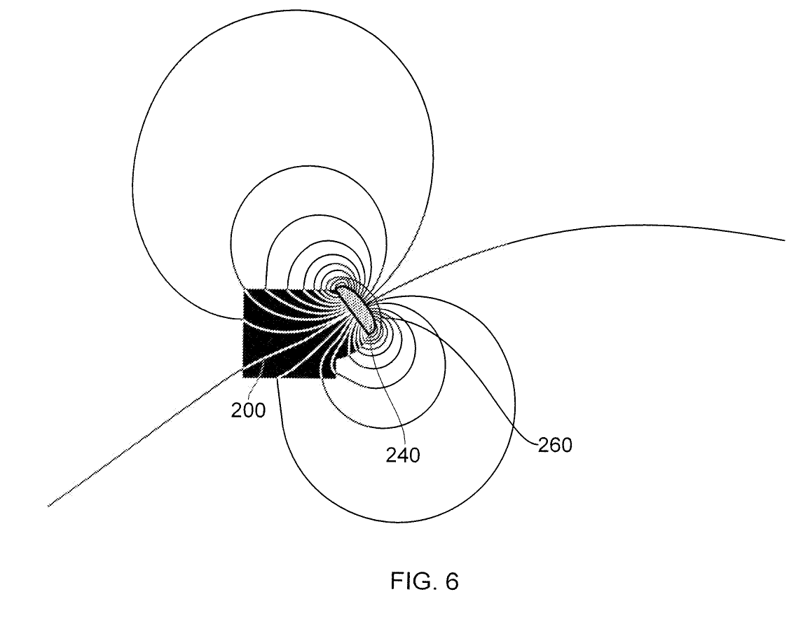

FIG. 6 is a schematic diagram showing typical magnetic flux lines from a magnet 240 mounted on a P-shaped support block 200 as described above. The magnetic field generated by this arrangement varies in both the radial and tangential direction relative to the curved surface 206 of the head 204 of the P-shaped support bracket 200. Thus, the Hall effect sensor can be used to measure either the radial or tangential component of the magnetic field. In FIG. 6 an arc 260 is drawn which represents the movement of the Hall effect sensor with changing position of the sledge in an embodiment where the tangential component is measured.

Preferably, the Hall effect sensor 252 and the magnet 240 are arranged so that there is a proportional relationship between the Hall effect sensor reading and orientation angle over at least a 40° range. Preferably, this proportional relationship is achieved over at least a 50° range, most preferably a 60° range. Such an arrangement results in a nearly linear relationship between the orientation of the inspection sensor module 100 and the Hall effect sensor reading over the range of angles generally of interest.

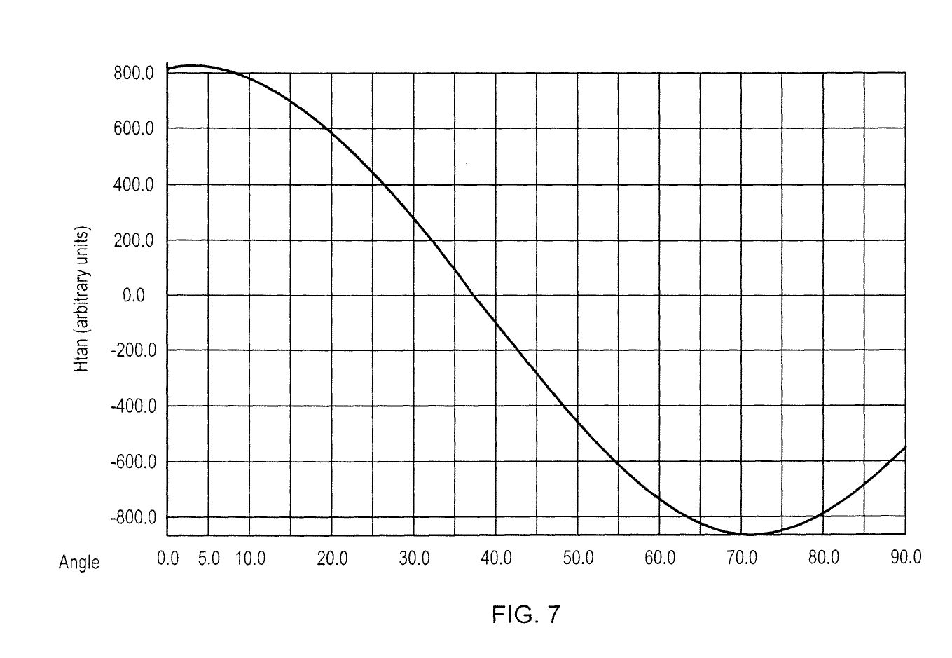

FIG. 7 is a graph showing an approximately linear relationship between tangential magnetic field and angular position of sensor relative to magnet over a range of more than 40° (e.g. between 10° and 50°). The magnet 240 may be partly embedded in the curved surface 206 of the head 204 of the P-shaped support bracket 200. The magnet 240 may be a brick or cuboid-shaped magnet. In the case that the magnet is a brick-shaped magnet, it is preferable that the surface 244 of the magnet 240 distal from the head 204 of the P-shaped support bracket 200 be shaped so that it follows an arc concentric with the arc of the curved surface 206 of the head 204. However, the surface 244 of the magnet 240 need not be curved. It may instead comprise a number of facets 240a, 240b, 240c positioned so as to approximate the shape of an arc, as shown in FIG. 4. Such facets may be formed through machining or forming. The use of a magnet with a facetted surface has the advantage that such magnets are easier and cheaper to shape than those with a curved surface.

Preferably, the brick-shaped magnet is positioned on the P-shaped support bracket 200 with its longitudinal axis at an angle of between 25° and 60° to the longitudinal axis of the pipeline vehicle 110. Most preferably, the magnet lies at a steep angle to the longitudinal axis of the pipeline vehicle, that is at around 60°. The inventors have found that at this orientation, the response of the Hall effect sensor 252 to the magnetic field around the magnet 240 is maximised.

FIG. 4 shows a chamfered magnet 240 mounted on a P-shaped support bracket 200. The magnet is magnetized in the through-thickness direction i.e. the magnetic field exits the magnet in a radial direction relative to the exposed surface of the magnet 240 and the curved surface 206 of the P-shaped support bracket 200.

FIG. 4 shows a single magnet 240 mounted on the P-shaped support bracket 200. However, a plurality of magnets may be used, which may be mounted in a series extending around the curved surface 206 of the P-shaped support bracket 200.

The magnet 240 may be a rare earth permanent magnet For example, it may be a samarium-cobalt magnet. This class of magnets has a high saturation magnetization and a low temperature coefficient (i.e. change of magnetization with temperature) of −0.045%/° C. The low temperature coefficient reduces the errors introduced by temperature variations within the pipeline.

In one embodiment the magnet 240 is S1TI2C017. Sintered or resin/plastic bonded SmCos or NdFeB magnets may also be suitable.

The inventors have found that using the inspection sensor module 100 of the present embodiment together with a chamfered magnet, it is possible to obtain a Hall effect sensor reading that varies linearly with angle over at least a 60° range. As a result, there exists a nearly linear relationship between the orientation of the inspection sensor module 100 and the Hall effect sensor reading over the range of angles generally of interest. In the present embodiment, the second (i.e. distal) end 130 of the sensor arm 120 is connected to a sledge 152 by a second hinge 150, and a sensor block 156 is mounted on the sledge 152. The sensor block 156 may be a conventional metal loss sensor that detects metal loss through magnetic flux measurements or another sensor used for the detection of cracks or metal loss defects. The sensor block 156 and the sensor sledge 152 on which it is mounted are both optional components. Instead, the second end 130 of the sensor arm 120 may simply have a tip that contacts and slides along the inner wall of the pipeline. Preferably, this tip is made from a wear-resistant material such as tungsten carbide.

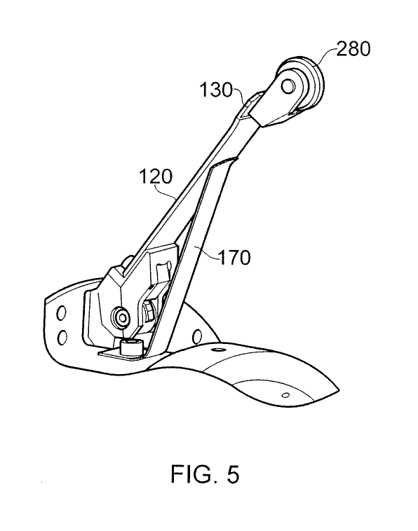

FIG. 5 shows an alternative embodiment, in which the distal end 130 of the sensor arm 120 is modified to comprise a wheel 280 that contacts and runs along the inner wall of the pipeline.

1. A sensor module for a pipeline vehicle, the sensor module comprising:
a support structure for mounting the module on the vehicle;
a sensor arm that is movable relative to the support structure;
a magnet mounted on one of the support structure and sensor arm; and
a magnetic flux sensor mounted on the other one of the support structure and sensor arm, wherein the magnet and magnetic flux sensor are movable relative to one another to detect the position of the sensor arm relative to the support structure.

2. A sensor module according to claim 1, wherein the magnet is mounted on the support structure and the magnetic flux sensor is mounted on the sensor arm to move therewith relative to the support structure.

3. A sensor module according to claim 1 wherein the sensor arm is connected at one end to the support structure.

4. A sensor module according to claim 1 wherein the sensor arm is pivotally connected to the support structure.

5. A sensor module according to claim 4, wherein the sensor arm is hinged relative to the support structure about an axle housed in the support structure.

6. A sensor module according to claim 1 including biasing means for biasing the sensor arm towards a deployed position relative to the support structure.

7. A sensor module according to claim 1, wherein the magnetic flux sensor is attached to or embedded within the sensor arm.

8. A sensor module according to claim 1, wherein the magnet is at least partly embedded in the support structure.

9. A sensor module according to claim 1, any preceding claim wherein the magnetic flux sensor is encased within a protective covering.

10. A sensor module according to claim 1, wherein the magnetic flux sensor is a Hall-effect sensor.

11. A sensor module according to claim 1, wherein the magnet comprises a rare earth permanent magnet.

12. A sensor module according to claim 11, wherein the magnet is a samarium-cobalt magnet or a neodymium-iron-boron magnet.

13. A pipeline vehicle having one or more sensor modules according to claim 1 mounted on an outer surface thereof.

14. A pipeline vehicle according to claim 13 having a plurality of sensor modules mounted circumferentially around a body of the vehicle, each sensor module having a sensor arm that is movable towards or away from the body of the vehicle.

15. A method of monitoring the characteristics of a pipe using a pipeline vehicle according to claim 13, the method including monitoring movement of a sensor arm of each sensor module to determine changes in the shape of a pipe cross-section.

16. A pipeline vehicle having a sensor module mounted thereon, the sensor module including a sensor arm pivotally connected to a support structure, the support structure being mounted on vehicle to permit relative movement between the sensor arm and vehicle in a first direction, wherein a compliant layer is mounted between the support structure and the vehicle to permit deflection of the sensor module relative to the vehicle in a second direction.

17. A pipeline vehicle according to claim 16, wherein the sensor arm is constrained to move in the first direction, and the second direction is offset from the first direction.

18. A pipeline vehicle according to claim 17, wherein the sensor arm is arranged to pivot in a flat plane relative to the support structure and the permitted deflection may enable movement of that plane relative to the vehicle.

19. A pipeline vehicle according to, claim 16 wherein the sensor module is a sensor module according to claim 1.
